(19) United States
(12) Patent Application Publication
(10) Pub. No.: US 2006/0216605 A1
(43) Pub. Date: Sep. 28, 2006

(54) Non-aqueous electrolyte secondary battery

(76) Inventors: Hironori Shirakata, Kobe-shi (JP); Hideki Kitao, Kobe-city (JP); Hiroyuki Akita, Kobe-shi (JP); Koji Hasumi, Kobe-shi (JP); Yoshinori Kida, Kobe-shi (JP); Toyoki Fujihara, Naruto-shi (JP); Kazuhisa Takeda, Itano-gun (JP); Naoya Nakanishi, Tokushima-shi (JP); Toshiyuki Nohma, Kobe-shi (JP)

Correspondence Address: KUBOVCIK & KUBOVCIK, SUITE 710, 900 17TH STREET NW, WASHINGTON, DC, 20006, US

(21) Appl. No.: 11/378,638

(22) Filed: Mar. 20, 2006

(30) Foreign Application Priority Data
Mar. 18, 2005 (JP) 2005-078647
Jan. 31, 2006 (JP) 2006-023287
Mar. 13, 2006 (JP) 2006-066991

(51) Int. Cl. H01M 4/58; H01M 4/50; H01M 4/52

(52) U.S. Cl. 429/231.95; 429/223; 429/224; 429/221; 429/231.1; 429/231.3

(57) ABSTRACT

In a non-aqueous electrolyte secondary battery employing an olivine-type lithium phosphate as a positive electrode active material, power regeneration performance is improved. The non-aqueous electrolyte secondary battery for use as a power source for regenerative charging includes: a positive electrode including a mixture layer containing a positive electrode active material, a binder agent, and a carbon material as a conductive agent; a negative electrode; and a non-aqueous electrolyte. The mixture layer contains, as the positive electrode active material, an olivine-type lithium phosphate represented by the formula LiMPO₄, where M is at least one element selected from the group consisting of Co, Ni, Mn, and Fe, and the mixture layer further contains a metal oxide such as a lithium-containing transition metal oxide containing at least Ni or Mn.

### BACKGROUND OF THE INVENTION

1. Field of the Invention

The present invention relates to non-aqueous electrolyte secondary batteries containing an olivine-type lithium phosphate (lithium-containing olivine-type phosphate) as a positive electrode active material.

2. Description of Related Art

Olivine-type lithium phosphate has drawn attention as a low-cost material for positive electrode active material in non-aqueous electrolyte batteries since it is composed of elements with richer reserves, such as Fe, Ni, and Mn, than lithium cobalt oxide, which has conventionally been used as a positive electrode active material. A problem with olivine-type lithium phosphate, however, has been that it has a high electrical resistance. For this reason, when a battery employing olivine-type lithium phosphate is charged and discharged at a large current, the resistance overvoltage increases and the battery voltage reduces, leading to insufficient power regeneration performance.

To resolve this problem, use of a composite material of a lithium-containing olivine-type phosphate and a carbon material as an active material has been investigated (Japanese Published Unexamined Patent Application Nos. 2002-110161, 2002-110162, 2002-110163, 2002-110164, and 2002-110165). Nevertheless, even with this technology, sufficient power regeneration performance has not been attained.

As a technique to improve thermal stability of positive electrode material, use of a mixture of a lithium-containing transition metal oxide and a lithium-containing olivine-type phosphate as an active material has been proposed (Japanese Published Unexamined Patent Application No. 2002-216755). With this technique, however, the weight proportions of the conductive agent and the binder agent in the positive electrode mixture are large and the content of the lithium-containing olivine-type phosphate in the positive electrode mixture-is small. Therefore, it is not possible to make full use of the power regeneration performance of lithium-containing olivine-type phosphate.

Japanese Published Unexamined Patent Application No. 2001-307730 discloses a non-aqueous electrolyte secondary battery having a positive electrode active material comprising a mixture of a first and a second lithium compounds in which a second lithium compound, for example, lithium cobalt oxide or lithium nickel cobalt oxide and the like, is mixed with a first lithium compound comprising an olivine-type lithium phosphate, and the first lithium compound is in a range of 10 to 50 weight %, to manufacture the battery at a low-cost, to make it interchangeable with a conventional lithium ion battery, and to obtain similar energy density.

When an olivine-type lithium phosphate containing iron (Fe) is left at a high temperature, Fe is eluted and deposited on a negative electrode and it causes an increase in the internal resistance of a battery.

Japanese Published Unexamined Patent Application No. 2001-307730 proposes a lithium ion battery employing a positive electrode active material containing a mixture of LiFePO₄ and another lithium compound. According to JP 2001-307730A, however, the proportion of LiFePO₄ mixed in the positive electrode active material is 50 wt. % or less, and it is not possible to obtain sufficient power regeneration performance.

It is an object of the present invention to provide a non-aqueous electrolyte secondary battery that utilizes olivine-type lithium phosphate as a positive electrode active material and has good power regeneration performance.

Another object of the present invention to provide a non-aqueous electrolyte secondary battery having also small increase of battery resistance during high temperature storage.

### BRIEF SUMMARY OF THE INVENTION

In order to accomplish the foregoing and other objects, the present invention provides a non-aqueous electrolyte secondary battery for use as a power source for regenerative charging, comprising: a positive electrode including a positive electrode mixture layer containing a positive electrode active material, a binding agent, and a carbon material as a conductive agent; a negative electrode; and a non-aqueous electrolyte, wherein the positive electrode mixture layer contains, as the positive electrode active material, an olivine-type lithium phosphate represented by the formula LiMPO₄, where M is at least one element selected from the group consisting of Co, Ni, Mn, and Fe, and a lithium-containing transition metal oxide containing at least Ni or Mn.

By using the olivine-type lithium phosphate as a positive electrode active material and allowing the positive electrode mixture layer, which contains the positive electrode active material, to contain the lithium-containing transition metal oxide, the present invention makes it possible to improve poor battery power regeneration performance that results from the high electrical resistance of the olivine-type lithium phosphate, and thus enables the battery to have good power regeneration performance.

It is believed that, when the lithium-containing transition metal oxide is contained in the mixture layer, the surfaces of the olivine-type lithium phosphate and the lithium-containing transition metal oxide are brought into contact with each other, allowing the electrically insulating layer on the surface of the olivine-type lithium phosphate to be activated. This facilitates diffusion of lithium ions, thereby improving the power regeneration performance.

### BRIEF DESCRIPTION OF THE DRAWINGS

FIG. 1 is a graph illustrating the relationship between charge IV resistance versus proportion of olivine-type lithium phosphate.

FIG. 2 is a graph illustrating the relationship between charge IV resistance versus proportion of olivine-type lithium phosphate. ▪ shows the results when LiZrNiCoMnO₂ is added, ⋄ shows the results when LiNiCoO₂ is added, and ▴ shows the results when LiZrMgCoO₂ is added.

### DETAILED DESCRIPTION OF THE INVENTION

In the present invention, an olivine-type lithium phosphate is used as a positive electrode active material, and a lithium-containing transition metal oxide containing at least Ni or Mn is contained in the positive electrode mixture layer that contains the positive electrode active material.

In the present invention, the lithium-containing transition metal oxide contains at least Ni or Mn, and preferably contains both Ni and Mn, and it is particularly preferable that the lithium-containing transition metal oxide further contain Co. Especially preferred is a lithium-containing transition metal oxide represented by the formula LiₐMnₓNi_{y}Co_{z}O₂, wherein 0<a≦1.5, x+y+z≦1, 0≦x≦0.8, 0≦y≦0.8, and z≧0. Especially, an average operating potential is close to that of the olivine-type lithium phosphate is preferable from the standpoint of detection of remaining capacity of a battery. A lithium-containing transition metal oxide having y>0.3, x<0.4 in the formula is particularly preferable.

The lithium-containing transition metal oxide may further contain at least one element selected from the group consisting of B, F, Mg, Al, Ti, Cr, V, Fe, Co, Ni, Cu, Zn, Nb, and Zr.

In addition, the lithium-containing transition metal oxide may be used together with a lithium-manganese composite oxide having a spinel structure. In this case, it is preferable that the weight ratio of the lithium-containing transition metal oxide to the lithium-manganese composite oxide be within the range of 10:90 to 90:10. Moreover, the lithium-manganese composite oxide may further contain at least one element selected from the group consisting of B, F, Mg, Al, Ti, Cr, V, Fe, Co, Ni, Cu, Zn, Nb, and Zr.

From the viewpoint of ensuring sufficient regenerative power, a preferred olivine-type lithium phosphate used as a positive electrode active material in the present invention may be LiFePO₄, which has a relatively low charge potential. It is preferable that the average particle size of the olivine-type lithium phosphate be 10 μm or less, and more preferably, 5 μm or less. Restricting average particle size to 10 μm or less enables the diffusion path of lithium to be shortened, leading to better power regeneration performance.

In the present invention, it is preferable that the content of the olivine-type lithium phosphate in the positive electrode mixture be within the range of from 50 weight % to 99 weight % with respect to the total weight of the olivine-type lithium phosphate and the lithium-containing transition metal oxide, or more preferably within the range of from 80 weight % to 99 weight %, or further preferably within the range of from 80 weight % to 99 weight %, from the viewpoint of ensuring sufficient power regeneration performance. If the content of the lithium-containing transition metal oxide is too small, improved power regeneration performance, which is the advantageous effect of the present invention, may not be attained. On the other hand, if the content of the lithium-containing transition metal oxide is too large, the battery voltage becomes high; and sufficient power regeneration performance may not be attained.

It is preferable that the positive electrode mixture in the present invention further contain a carbon material, serving as a conductive agent, in an amount of 3 weight % to 10 weight %. From the viewpoint of ensuring sufficient energy density, the content of the carbon material and the binding agent in the mixture layer is preferably 10 weight % or less. Specific examples of the carbon material include massive carbon such as acetylene black and fibrous carbon.

In the present invention, the solute of the non-aqueous electrolyte may be any lithium salt that is generally used as a solute in lithium secondary batteries. Examples of such a lithium salt include LiPF₆, LiBF₄, LiCF₃SO₃, LiN(CF₃SO₂)₂, LiN(C₂F₆SO₂)₂, LiN(CF₃SO₂)(C₄F₉SO₂), LiC(C₂F₅SO₂)₃, LiAs₆, LiCl₄, LiClO₄, and mixtures thereof. In addition to these salts, it is preferable that a lithium salt having an oxalato complex as an anion be contained. An example of the lithium salt having an oxalato complex as an anion is lithium bis(oxalato)borate.

The solvent of the non-aqueous electrolyte used in the present invention may be any solvent that has conventionally been used as a solvent for an electrolyte in non-aqueous electrolyte secondary batteries. Examples of the solvent include: cyclic carbonates, such as ethylene carbonate; propylene carbonate, butylene carbonate, and vinylene carbonate; and chain carbonates, such as dimethyl carbonate, methylethyl carbonate, and diethyl carbonate. Particularly preferable is a mixed solvent of a cyclic carbonate and a chain carbonate.

The negative electrode active material used in the present invention is not particularly limited, but is preferably a carbon material.

The non-aqueous electrolyte secondary battery according to the present invention exhibits good power regeneration performance and is therefore suitable for a power source for regenerative charging in hybrid automobiles, power assisted bicycles, and the like.

Hereinbelow, the present invention is described in further detail based on examples thereof. It should be construed, however, that the present invention is not limited to the following examples but various changes and modifications are possible without departing from the scope of the invention.

### EXAMPLE 1

Preparation of Positive Electrode Active Material

An olivine-type lithium phosphate (LiFePO₄) was prepared in the following manner. First, starting materials, iron phosphate octahydrate (Fe₃(PO₄)₂.8H₂O) and lithium phosphate (Li₃PO₄), were mixed at a mole ratio of 1:1 and kneaded with the use of a planetary ball mill in the following manner. The mixture was put into a 10 cm-diameter stainless steel pots, along with 1 cm-diameter stainless steel balls, and the planetary ball mill was operated under the following conditions: radius of revolution: 30 cm, revolution speed: 150 rpm, rotation speed: 150 rpm, and operation duration: 12 hours.

Next, the resultant mixture was sintered by an electric furnace at a temperature of 600° C. in a non-oxidizing atmosphere for 10 hours, and thereby LiFePO₄ was obtained.

A lithium-containing transition metal oxide LiZr_{0.01}(Ni_{0.4}Co_{0.3}Mn_{0.3})_{0.99}O₂ was prepared in the following manner. Li₂CO₃, (Ni_{0.4}Co_{0.3}Mn_{0.3})₃O₄, and ZrO₂ were mixed together at a mole ratio of 50:33:1, and the mixture was sintered in an air atmosphere at 900° C. for 20 hours. Thus, LiZr_{0.01}(Ni_{0.4}Co_{0.3}Mn_{0.3})_{0.99}O₂ was prepared.

Preparation of Positive Electrode

The olivine-type lithium phosphate and the lithium-containing transition metal oxide prepared in the above-described manner were mixed at a weight ratio of 2:8. To the mixture, a carbon material serving as a conductive agent, and an N-methyl-pyrrolidone solution in which polyvinylidene fluoride serving as a binding agent was dissolved, were added and mixed together so that the weight ratio of the active materials, the conductive agent, and the binder agent became 90:5:5. Thus, a positive electrode slurry was prepared.

The prepared slurry was applied onto an aluminum foil serving as a current collector and then dried. Thereafter, the resultant material was pressure-rolled using pressure rollers, and a current collector tab was attached thereto. Thus, a positive electrode was prepared.

Preparation of Electrolyte Solution

LiPF₆ as a solute was dissolved at a concentration of 1 mole/liter into a mixed solvent of 3:7 volume ratio of ethylene carbonate (EC) and diethyl carbonate (DEC), to thus prepare an electrolyte solution.

Preparation of Three-Electrode Beaker Cell

A three-electrode beaker cell Al was prepared using the positive electrode prepared in the above-described manner for the working electrode, lithium metal for the counter electrode and the reference electrode, and the just-described electrolyte solution for the electrolyte solution.

### EXAMPLE 2

A test cell A2 was prepared in the same manner as in Example 1, except that the olivine-type lithium phosphate and the lithium-containing transition metal oxide were mixed at a weight ratio of 4:6.

### EXAMPLE 3

A test cell A3 was prepared in the same manner as in Example 1, except that the olivine-type lithium phosphate and the lithium-containing transition metal oxide were mixed at a weight ratio of 6:4.

### EXAMPLE 4

A test cell A4 was prepared in the same manner as in Example 1, except that the olivine-type lithium phosphate and the lithium-containing transition metal oxide were mixed at a weight ratio of 8:2.

### EXAMPLE 5

A test cell AS was prepared in the same manner as in Example 1, except that the olivine-type lithium phosphate and the lithium-containing transition metal oxide were mixed at a weight ratio of 95:5.

### EXAMPLE 6

A test cell A6 was prepared in the same manner as in Example 1, except that the olivine-type lithium phosphate and the lithium-containing transition metal oxide were mixed at a weight ratio of 99:5.

### COMPARATIVE EXAMPLE 1

A test cell B1 was prepared in the same manner as in Example 1, except that only the olivine-type lithium phosphate was used as the positive electrode active material.

Charge-Discharge Test

The above-described cells were charged at 5 mA to 4.3 V (vs. Li/Li⁺) at room temperature, then rested for 10 minutes, and then discharged at 5 mA to 2.75 V (vs. Li/Li⁺). This charge-discharge cycle was repeated 5 times, and thereafter, the cells were charged at 5 mA to 4.3 V (vs. Li/Li⁺) to be brought to a charged state.

IV Resistance Measurement Test

IV resistance was measured as follows.

(1) 5 mA charge (10 seconds)→rest (10 minutes)→5 mA discharge (10 seconds)→rest (10 minutes)

(2) 10 mA charge (10 seconds)→rest (10 minutes)→10 mA discharge (10 seconds)→rest (10 minutes)

(3) 20 mA charge (10 seconds)→rest (10 minutes)→20 mA discharge (10 seconds)→rest (10 minutes)

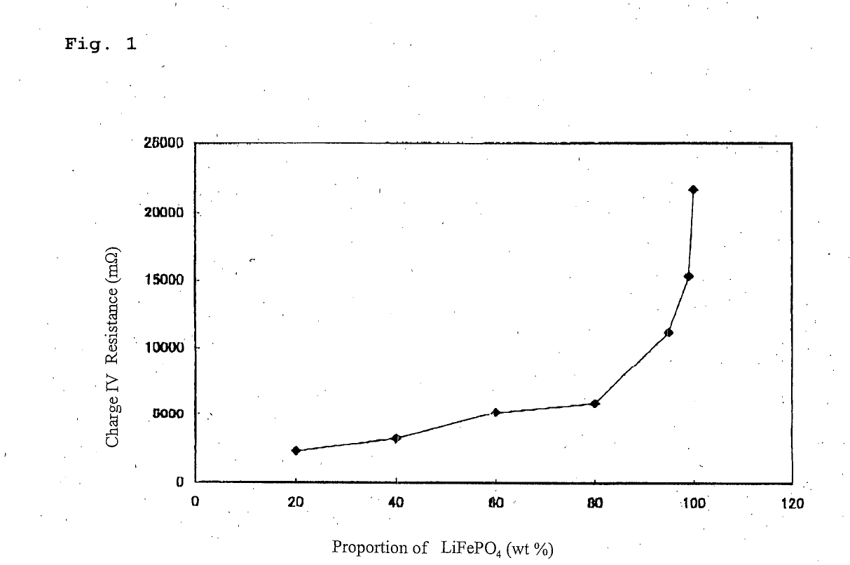

The charge-discharge tests (1) to (3) were carried out in that order at room temperature. The highest potential reached in each charging was measured, and from the gradient of the current values, IV resistance was calculated. The results of the calculation are shown in Table 1. Table 1 also shows open circuit voltage (OCV) at 50% state of charge (SOC). FIG. 1 illustrates the relationship between the proportions of LiFePO₄ and charge IV resistances.

TABLE 1

| | | Proportion | | | Open |
|---|---|---|---|---|---|
| | | of | Proportion of | | circuit |
| | | LiFePO₄ | LiZr_{0.01}(Ni_{0.4}Co_{0.3}Mn_{0.3})_{0.99}O₂ | Charge IV | voltage at |
| | Cell | (wt. %) | (wt. %) | resistance (mΩ) | 50% SOC |
| Example 1 | A1 | 20 | 80 | 2323 | 3.78 |
| Example 2 | A2 | 40 | 60 | 3263 | 3.72 |
| Example 3 | A3 | 60 | 40 | 5220 | 3.48 |
| Example 4 | A4 | 80 | 20 | 5940 | 3.42 |
| Example 5 | A5 | 95 | 5 | 11200 | 3.42 |
| Example 6 | A6 | 99 | 1 | 15350 | 3.42 |
| Comp. | B1 | 100 | 0 | 21649 | 3.42 |
| Example | | | | | |

As will be clearly understood from Table 1 and FIG. 1, the IV resistance at charge was considerably lowered by adding the lithium-containing transition metal oxide to LiFePO₄, in comparison with the case in which LiFePO₄ alone was used as the positive electrode active material, and power regeneration performance was improved. It is believed that this effect was not a simple improvement in power regeneration performance such that a simple weighted average holds, but that it resulted because the adding of the lithium-containing transition metal oxide to the olivine-type lithium phosphate unusually reduced the electrical resistance of the olivine-type lithium phosphate. Although the mechanism of its working is not yet clear, it is believed that power regeneration performance improved for the following reason. The surfaces of the olivine-type lithium phosphate and the lithium-containing transition metal oxide came into contact-with each other, thereby allowing the electrically insulating layer on the surface of the olivine-type lithium phosphate to be activated. Consequently, diffusion of lithium ions was facilitated, and power regeneration performance was improved.

In this case, OCV at 50% SOC must be low from the viewpoint of ensuring sufficient power regeneration performance; therefore, it is preferable that the -proportion of LiFePO₄ be within the range of 99 weight % to 50 weight %, and more preferably within the range of 99 weight % to 80 weight %. Accordingly, it is preferable that the content of the lithium-containing transition metal oxide be within the range of from 1 weight % to 50 weight %, and more preferably within the range of from 1 weight % to 20 weight %.

### EXAMPLE 7

A test cell A7 was prepared in the same manner as in Example 1, except that a lithium-containing transition metal oxide LiZr_{0.005}(Ni_{0.4}Co_{0.3}Mn_{0.3})_{0.995}O₂ and positive electrode were prepared in the following manner. Li₂CO₃, (Ni_{0.4}Co_{0.3}Mn_{0.3})₃O₄, and ZrO₂ were mixed together at a mole ratio of 300:199:3, and the mixture was sintered in an air atmosphere at 900° C. for 20 hours. Thus, LiZr_{0.005}(Ni_{0.4}Co_{0.3}Mn_{0.3})_{0.995}O₂ (hereinafter LiZrNiCoMnO₂) was prepared.

A lithium-containing transition metal oxide LiNi_{0.8}Co_{0.2}O₂ was prepared in the following manner. Li₂CO₃ and (Ni_{0.8}Co_{0.2})₃O₄ were mixed together at a mole ratio of 3:2, and the mixture was sintered in an air atmosphere at 900° C. for 20 hours. Thus, LiNi_{0.8}Co_{0.2}O₂ (hereinafter LiNiCoO₂) was prepared.

A lithium-containing transition metal oxide LiZr_{0.005}MgO_{0.005}CO_{0.99}O₂ was prepared in the following manner. Li₂CO₃, Co₃O₄, ZrO₄ and MgO were mixed together at a mole ratio of 100:66:1:1, and the mixture was sintered in an air atmosphere at 900° C. for 20 hours. Thus, LiZr_{0.005}Mg_{0.005}Co_{0.99}O₂ (hereinafter LiZrMgCoO₂) was prepared.

Preparation of Positive Electrode

The olivine-type lithium phosphate and LiZrNiCoMnO₂ prepared in the above-described manner were mixed at a weight ratio of 2:8. To the mixture, a carbon material serving as a conductive agent, and an N-methyl-pyrrolidone solution in which polyvinylidene fluoride serving as a binding agent was dissolved, were added and mixed together so that the weight ratio of the active materials, the conductive agent, and the binding agent became 90:5:5. Thus, a positive electrode slurry was prepared.

### EXAMPLE 8

A test cell A8 was prepared in the same manner as in Example 7, except that the olivine-type lithium phosphate and LiZrNiCoMnO₂ were mixed at a weight ratio of 4:6.

### EXAMPLE 9

A test cell A9 was prepared in the same manner as in Example 7, except that the olivine-type lithium phosphate and LiZrNiCoMnO₂ were mixed at a weight ratio of 6:4.

### EXAMPLE 10

A test cell A10 was prepared in the same manner as in Example 7, except that the olivine-type lithium phosphate and LiZrNiCoMnO₂ were mixed at a weight ratio of 8:2.

### EXAMPLE 11

A test cell All was prepared in the same manner as in Example 7, except that the olivine-type lithium phosphate and LiZrNiCoMnO₂ were mixed at a weight ratio of 95:5.

### EXAMPLE 12

A test cell A12 was prepared in the same manner as in Example 7, except that the olivine-type lithium phosphate and LiZrNiCoMnO₂ were mixed at a weight ratio of 99:1.

### EXAMPLE 13

A test cell A13 was prepared in the same manner as in Example 7, except that the olivine-type lithium phosphate and LiNiCoO₂ were mixed at a weight ratio of 2:8.

### EXAMPLE 14

A test cell A14 was prepared in the same manner as in Example 7, except that the olivine-type lithium phosphate and LINiCoO₂ were mixed at a weight ratio of 5:5.

### EXAMPLE 15

A test cell A15 was prepared in the same manner as in Example 7, except that the olivine-type lithium phosphate and LiNiCoO₂ were mixed at a weight ratio of 85:15.

### EXAMPLE 16

A test cell A16 was prepared in the same manner as in Example 7, except that the olivine-type lithium phosphate and LiNiCoO₂ were mixed at a weight ratio of 9:1.

### EXAMPLE 17

A test cell A17 was prepared in the same manner as in Example 7, except that the olivine-type lithium phosphate and LiNiCoO₂ were mixed at a weight ratio of 95:5.

### EXAMPLE 18

A test cell A17 was prepared in the same manner as in Example 7, except that the olivine-type lithium phosphate and LiNiCoO₂ were mixed at a weight ratio of 99:1.

### EXAMPLE 19

A test cell A19 was prepared in the same manner as in Example 7, except that the olivine-type lithium phosphate and LiZrMgCoO₂ were mixed at a weight ratio of 95:5.

### EXAMPLE 20

A test cell A20 was prepared in the same manner as in Example 7, except that the olivine-type lithium phosphate and LiZrMgCoO₂ were mixed at a weight ratio of 99:1.

The Charge-Discharge Test of test cells A7 to A20 were carried in the same manner as described above.

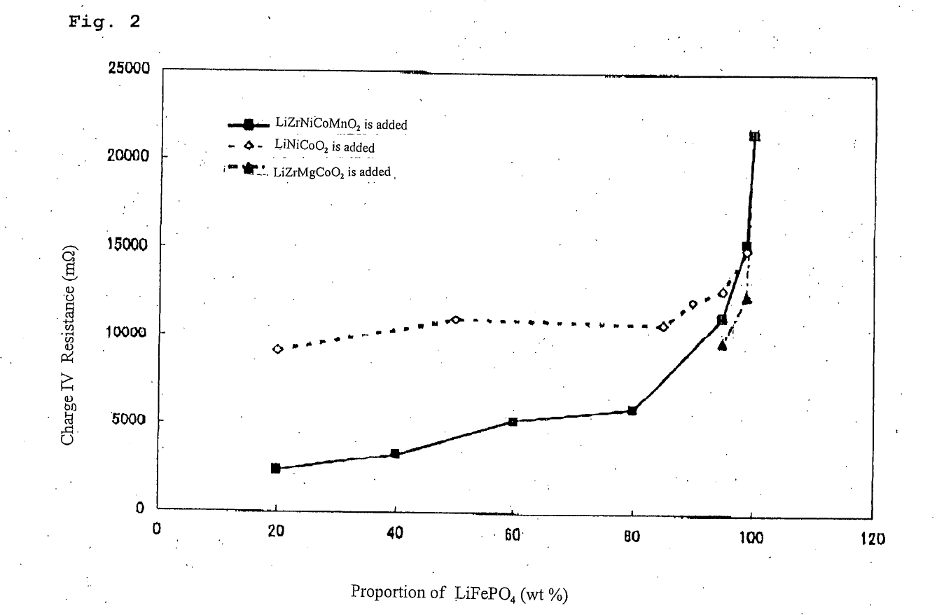

The IV Resistance Measurement Test of test cells A7 to A20 were carried in the same manner as described above. The results of the calculation are shown in Table 2. Table 2 also shows open circuit voltage (OCV) at 50% state of charge (SOC). FIG. 2 illustrates the relationship between the proportions of LiFePO₄ and charge IV resistances.

TABLE 2

| | | Lithium- | | | Open circuit |
|---|---|---|---|---|---|
| | | containing | | Charge | voltage at |
| | | transition metal | LiFePO₄ | IV | 50% SOC |
| | Cell | oxide | (wt %) | Resistance (mΩ) | (V vs. Li/Li⁺) |
| Example 7 | A7 | LiZrNiCoMnO₂ | 20 | 2323 | 3.78 |
| Example 8 | A8 | LiZrNiCoMnO₂ | 40 | 3263 | 3.72 |
| Example 9 | A9 | LiZrNiCoMnO₂ | 60 | 5220 | 3.48 |
| Example 10 | A10 | LiZrNiCoMnO₂ | 80 | 5940 | 3.42 |
| Example 11 | A11 | LiZrNiCoMnO₂ | 95 | 11200 | 3.42 |
| Example 12 | A12 | LiZrNiCoMnO₂ | 99 | 15350 | 3.42 |
| Example 13 | A13 | LiNiCoO₂ | 20 | 9179 | 3.73 |
| Example 14 | A14 | LiNiCoO₂ | 50 | 11030 | 3.67 |
| Example 15 | A15 | LiNiCoO₂ | 85 | 10780 | 3.44 |
| Example 16 | A16 | LiNiCoO₂ | 90 | 12040 | 3.44 |
| Example 17 | A17 | LiNiCoO₂ | 95 | 12670 | 3.44 |
| Example 18 | A18 | LiNiCoO₂ | 99 | 15000 | 3.44 |
| Example 19 | A19 | LiZrMgCoO₂ | 95 | 9800 | 3.44 |
| Example 20 | A20 | LiZrMgCoO₂ | 99 | 12400 | 3.44 |
| Comparative | B1 | — | 100 | 21649 | 3.42 |
| Example 1 | | | | | |

As will be clearly understood from Table 2 and FIG. 2, the IV resistance at charge was considerably lowered by adding the lithium-containing transition metal oxide to LiFePO₄, in comparison with the case in which LiFePO₄ alone was used as the positive electrode active material, and power regeneration performance was improved. It is believed that deposition of electrochemically inactive FePO₄ on the surface of the olivine-type lithium phosphate is inhibited and electron conductivity is improved by adding the lithium-containing transition metal oxide to a mixture layer, i.e., mixing two active materials having different potentials.

In this case, OCV at 50% SOC must be low from the viewpoint of ensuring sufficient power regeneration performance; therefore, it is preferable that the proportion of LiFePO₄ be within the range of 99 weight % to 50 weight %, more preferably within the range of 99 weight % to 60 weight %, and further preferably within the range of 99 weight % to 80 weight %. Accordingly, it is preferable that the content of the lithium-containing transition metal oxide be within the range of from 1 weight % to 50 weight %, more preferably within the range of from 1 weight % to 40 weight %, and further preferably within the range of from 1 weight % to 20 weight %.

### EXAMPLE 21

A test cell A21 was prepared in the same manner as in Example 1, except that a negative electrode and battery were prepared in the following manner. A charge-discharge test and a high temperature storage test were conducted.

Preparation of Negative Electrode

Polyvinylidene fluoride (PVDF), a binder, was dissolved in N-methylpyrrolidone (NMP) to prepare a binder solution. Graphite powder was added to the binder solution at a weight ratio of 85:15 (graphite:PVDF) to prepare a slurry. Then the slurry was coated on both side of a copper foil at a thickness of 20 μm to prepare a negative electrode.

Assembly of Battery

A separator made of polyethylene fine porous film having ion permeability was wound several times, the negative electrode and the positive electrode were wound many times spirally to face each other at opposed positions across the separator to prepare an electrode body. The electrode body was housed in a battery can, and the electrolyte was poured and the can was sealed-to prepare a battery A21 having 1200 mAh of battery capacity.

Charge-Discharge Test

The battery was charged at 1000 mA of a constant current and a constant voltage (50mA CUT) to 4.2 V, then was discharged at 1000 mA to 2.4 V (ending discharge voltage was set at 2.4 V) to calculate capacity of the battery.

High Temperature Storage Test

The battery after being charged to 4.2 V at the condition described in the charge-discharge test was stored at 60° C. in a constant-temperature bath for 20 days. Then the battery was discharged at the condition described in the charge-discharge test to measure a remainig capacity. A battery capacity was checked at the charge and discharge condition described in the charge-discharge test, and capacity recovery rate was calculated by equation 1.
Capacity Recovery Rate (%)=capacity after storage test/capacity before storage test×100
Measurement of Battery Resistance

Battery resistance was measured using a battery after discharged to 2.4 V at the condition described above by measuring resistance at 1 kHz.

Quantitative Determination of Eluted Fe

The battery on which the storage test was conducted was discharged to 2.4 V at the discharge condition described above and was taken apart to obtain the negative electrode. An amount of Fe in the negative electrode active material was analyzed by an Inductively Coupled Plasma (ICP).

Comparative Electrode 2

A comparative battery B2 having 1050 mAh of capacity was prepared in the same manner as in Example 21, except that LiFePo₄ was used as a positive electrode active material. The charge-discharge test, high temperature storage test, measurement of battery resistance and quantitative determination of eluted Fe were conducted on the battery B2. The results of tests of batteries A21 and B2 are shown in Table 3.

TABLE 3

| | | | | | Amount of |
|---|---|---|---|---|---|
| | | | | | Fe in |
| | | | | | Negative |
| | | | | Increase | electrode |
| | | | Capacity | of | active |
| | | | recovery | internal | material |
| | | | rate | resistance | after |
| | | LiFePO₄ | after | after | storage |
| | | ratio | storage | storage | test |
| | Battery | (wt %) | test (%) | test (mΩ) | (μg/cm²) |
| Example 22 | A21 | 80 | 86.4 | 0 | 0.53 |
| Comparative | B2 | 100 | 67.7 | 13.8 | 21.3 |
| Example 2 | | | | | |

As will be clearly understood from Table 2, the amount of eluted Fe was significantly suppressed by adding the lithium-containing transition metal oxide to LiFePO₄. The mechanisms or reasons are not clear. However, it is believed that the lithium-containing transition metal oxide contributes to inhibit formation of electrochemically inactive FePO₄ on the surface of the olivine-type lithium phosphate and to decrease Fe.(III) which is easily eluted to improve storage characteristics.

As shown in the results of Examples 7 to 20, a significant effect of reduction of resistance is obtained by adding a small amount of the lithium-containing transition metal oxide to the olivine-type lithium phosphate. Therefore, the composition of the lithium-containing transition metal oxide, or mixing ratio is not limited that used in Example 21 to obtain the effect of improvement of storage characteristics.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and not for limiting the invention as defined by the appended claims and their equivalents.

This application claims priority of Japanese patent application Nos. 2005-078647, 2006-023287 and 2006-066991 filed Mar. 18, 2005, Jan. 31, 2006, and Mar. 13, 2006, respectively, which are incorporated herein by reference.

What is claimed is:

1. A non-aqueous electrolyte secondary battery, comprising:
a positive electrode-including a mixture layer containing a positive electrode active material, a binder agent, and a carbon-material as a conductive agent;
a negative electrode; and
a non-aqueous electrolyte, wherein
the mixture layer contains, as the positive electrode active material, an olivine-type lithium phosphate represented by the formula LiMPO₄, where M is at least one element selected from the group consisting of Co, Ni, Mn, and Fe, and a lithium-containing transition metal oxide containing at least Ni and Mn.

2. The non-aqueous electrolyte secondary battery according to claim 1, wherein the lithium-containing transition metal oxide further contains Co.

3. The non-aqueous electrolyte secondary battery according to claim 1, wherein the content of the olivine-type lithium phosphate is within the range of from 50 weight % to 99 weight % with respect to the total weight of the olivine-type lithium phosphate and the lithium-containing transition metal oxide.

4. The non-aqueous electrolyte secondary battery according to claim 2, wherein the content of the olivine-type lithium phosphate is within the range of from 50 weight % to 99 weight % with respect to the total weight of the olivine-type lithium phosphate and the lithium-containing transition metal oxide.

5. The non-aqueous electrolyte secondary battery according to claim 1, wherein the lithium-containing transition metal oxide further contains at least one element selected from the group consisting of B, F, Mg, Al, Ti, Cr, V, Fe, Cu, Zn, Nb, and Zr.

6. The non-aqueous electrolyte secondary battery according to claim 2, wherein the lithium-containing transition metal oxide further contains at least one element selected from the group consisting of B, F, Mg, Al, Ti, Cr, V, Fe, Cu, Zn, Nb, and Zr.

7. The non-aqueous electrolyte secondary battery according to claim 3, wherein the lithium-containing transition metal oxide further contains at least one element selected from the group consisting of B, F, Mg, Al, Ti, Cr, V, Fe, Cu, Zn, Nb, and Zr.

8. The non-aqueous electrolyte secondary battery according to claim 4, wherein the lithium-containing transition metal oxide further contains at least one element selected from the group consisting of B, F, Mg, Al, Ti, Cr, V, Fe, Cu, Zn, Nb, and Zr.

9. The non-aqueous electrolyte secondary battery according to claim 1, wherein the olivine-type lithium phosphate is LiFePO₄.

10. The non-aqueous electrolyte secondary battery according to claim 2, wherein the olivine-type lithium phosphate is LiFePO₄.

11. The non-aqueous electrolyte secondary battery according to claim 3, wherein the olivine-type lithium phosphate is LiFePO₄.

12. The non-aqueous electrolyte secondary battery according to claim 4, wherein the olivine-type lithium phosphate is LiFePO₄.

13. The non-aqueous electrolyte secondary battery according to claim 5, wherein the olivine-type lithium phosphate is LiFePO₄.

14. The non-aqueous electrolyte secondary battery according to claim 6, wherein the olivine-type lithium phosphate is LiFePO₄.

15. The non-aqueous electrolyte secondary battery according to claim 7, wherein the olivine-type lithium phosphate is LiFePO₄.

16. The non-aqueous electrolyte secondary battery according to claim 8, wherein the olivine-type lithium phosphate is LiFePO₄.

17. A non-aqueous electrolyte secondary battery, comprising:
a positive electrode including a mixture layer containing a positive electrode active material, a binder agent, and a carbon material as a conductive agent;
a negative electrode; and
a non-aqueous electrolyte, wherein
the mixture layer contains, as the positive electrode active material, an olivine-type lithium phosphate represented by the formula LiMPO₄, where M is at least one element selected from the group consisting of Co, Ni, Mn, and Fe, and a lithium-containing transition metal oxide containing at least Co; Ni or Mn, and the content of the olivine-type lithium phosphate is within the range of from 50 weight % to 99 weight % with respect to the total weight of the olivine-type lithium phosphate and the lithium-containing transition metal oxide.

18. The non-aqueous electrolyte secondary battery according to claim 17, wherein the lithium-containing transition metal oxide contains Co.

19. The non-aqueous electrolyte secondary battery according to claim 17, wherein the lithium-containing transition metal oxide further contains at least one element selected from the group consisting of B, F, Mg, Al, Ti, Cr, V, Fe, Cu, Zn, Nb, and Zr.

20. The non-aqueous electrolyte secondary battery according to claim 18, wherein the lithium-containing transition metal oxide further contains at least one element selected from the group consisting of B, F, Mg, Al, Ti, Cr, V, Fe, Cu, Zn, Nb, and Zr.

21. The non-aqueous electrolyte secondary battery according to claim 17, wherein the olivine-type lithium phosphate is LiFePO₄.

22. The non-aqueous electrolyte secondary battery according to claim 18, wherein the olivine-type lithium phosphate is LiFePO₄.

23. The non-aqueous electrolyte secondary battery according to claim 19, wherein the olivine-type lithium phosphate is LiFePO₄.

24. The non-aqueous electrolyte secondary battery according to claim 20, wherein the olivine-type lithium phosphate is LiFePO₄.

25. A non-aqueous electrolyte secondary battery for use as a power source for regenerative charging, comprising:
a positive electrode including a mixture layer containing a positive electrode active material, a binder agent, and a carbon material as a conductive agent;
a negative electrode; and
a non-aqueous electrolyte, wherein
the mixture layer contains, as the positive electrode active material, an olivine-type lithium phosphate represented by the formula LiMPO₄, where M is at least one element selected from the group consisting of Co, Ni, Mn, and Fe, and a lithium-containing transition metal oxide containing at least Ni and Mn.

26. The non-aqueous electrolyte secondary battery for use as a power source for regenerative charging according to claim 25, wherein the lithium-containing transition metal oxide further contains Co.

27. The non-aqueous electrolyte secondary battery for use as a power source for regenerative charging according to claim 25, wherein the content of the olivine-type lithium phosphate is within the range of from 50 weight % to 99 weight % with respect to the total weight of the olivine-type lithium phosphate and the lithium-containing transition metal oxide.

28. The non-aqueous electrolyte secondary battery for use as a power source for regenerative charging according to claim 26, wherein the content of the olivine-type lithium phosphate is within the range of from 50 weight % to 99 weight % with respect to the total weight of the olivine-type lithium phosphate and the lithium-containing transition metal oxide.

29. The non-aqueous electrolyte secondary battery for use as a power source for regenerative charging according to claim 25, wherein the lithium-containing transition metal oxide further contains at least one element selected from the group consisting of B, F, Mg, Al, Ti, Cr, V, Fe, Cu, Zn, Nb, and Zr.

30. The non-aqueous electrolyte secondary battery for use as a power source for regenerative charging according to claim 26, wherein the lithium-containing transition metal oxide further contains at least one element selected from the group consisting of B, F, Mg, Al, Ti, Cr, V, Fe, Cu, Zn, Nb, and Zr.

31. The non-aqueous electrolyte secondary battery for use as a power source for regenerative charging according to claim 27, wherein the lithium-containing transition metal oxide further contains at least one element selected from the group consisting of B, F, Mg, Al, Ti, Cr, V, Fe, Cu, Zn, Nb, and Zr.

32. The non-aqueous electrolyte secondary battery for use as a power source for regenerative charging according to claim 28, wherein the lithium-containing transition metal oxide further contains at least one element selected from the group consisting of B, F, Mg, Al, Ti, Cr, V, Fe, Cu, Zn, Nb, and Zr.

33. The non-aqueous electrolyte secondary battery for use as a power source for regenerative charging according to claim 25, wherein the olivine-type lithium phosphate is LiFePO₄.

34. The non-aqueous electrolyte secondary battery for use as a power source for regenerative charging according to claim 26, wherein the olivine-type lithium phosphate is LiFePO₄.

35. The non-aqueous electrolyte secondary battery for use as a power source for regenerative charging according to claim 27, wherein the olivine-type lithium phosphate is LiFePO₄.

36. The non-aqueous electrolyte secondary battery for use as a power source for regenerative charging according to claim 28, wherein the olivine-type lithium phosphate is LiFePO₄.

37. The non-aqueous electrolyte secondary battery for use as a power source for regenerative charging according to claim 29, wherein the olivine-type lithium phosphate is LiFePO₄.

38. The non-aqueous electrolyte secondary battery for use as a power source for regenerative charging according to claim 30, wherein the olivine-type lithium phosphate is LiFePO₄.

39. The non-aqueous electrolyte secondary battery for use as a power source for regenerative charging according to claim 31, wherein the olivine-type lithium phosphate is LiFePO₄.

40. The non-aqueous electrolyte secondary battery for use as a power source for regenerative charging according to claim 32, wherein the olivine-type lithium phosphate is LiFePO₄.

41. A non-aqueous electrolyte secondary battery for use as a power source for regenerative charging, comprising:
a positive electrode including a mixture layer containing a positive electrode active material, a binder agent, and a carbon material as a conductive agent;
a negative electrode; and
a non-aqueous electrolyte, wherein
the mixture layer contains, as the positive electrode active material, an olivine-type lithium phosphate represented by the formula LiMPO₄, where M is at least one element selected from the group consisting of Co, Ni, Mn, and Fe, and a lithium-containing transition metal oxide containing at least Co, Ni or Mn, and the content of the olivine-type lithium phosphate is within the range of from 50 weight % to 99 weight % with respect to the total weight of the olivine-type lithium phosphate and the lithium-containing transition metal oxide.

42. The non-aqueous electrolyte secondary battery for use as a power source for regenerative charging according to claim 41, wherein the lithium-containing transition metal oxide contains Co.

43. The non-aqueous electrolyte secondary battery for use as a power source for regenerative charging according to claim 41, wherein the lithium-containing transition metal oxide further contains at least one element selected from the group consisting of B, F, Mg, Al, Ti, Cr, V, Fe, Cu, Zn, Nb, and Zr.

44. The non-aqueous electrolyte secondary battery for use as a power source for regenerative charging according to claim 42, wherein the lithium-containing transition metal oxide further contains at least one element selected from the group consisting of B, F, Mg, Al, Ti, Cr, V, Fe, Cu, Zn, Nb, and Zr.

45. The non-aqueous electrolyte secondary battery for use as a power source for regenerative charging according to claim 41, wherein the olivine-type lithium phosphate is LiFePO₄.

46. The non-aqueous electrolyte secondary battery for use as a power source for regenerative charging according to claim 42, wherein the olivine-type lithium phosphate is LiFePO₄.

47. The non-aqueous electrolyte secondary battery for use as a power source for regenerative charging according to claim 43, wherein the olivine-type lithium phosphate is LiFePO₄.

48. The non-aqueous electrolyte secondary battery for use as a power source for regenerative charging according to claim 44, wherein the olivine-type lithium phosphate is LiFePO₄.
